(19) United States
(12) Patent Application Publication
(10) Pub. No.: US 2012/0282432 A1
(43) Pub. Date: Nov. 8, 2012

(54) FLAME RETARDANT PVC PLASTISOL COMPOSITIONS USEFUL AS COATINGS, ADHESIVES AND BACKINGS

(75) Inventors: Elisabeth Serafeim Papazoglou, Yardley, PA (US); Kenneth Reese Malin, Swedesboro, NJ (US); Constantinos J. Papathomas, Yardley, PA (US)

(73) Assignee: Polymer Products Company, Inc., Stockertown, PA (US)

(21) Appl. No.: 13/420,856

(22) Filed: Mar. 15, 2012

Related U.S. Application Data
(60) Provisional application No. 61/454,100, filed on Mar. 18, 2011.

(51) Int. Cl. C08K 3/22; B32B 37/20; B32B 33/00; C08K 5/521

(52) U.S. Cl. 428/95; 524/145; 524/409; 156/242

(57) ABSTRACT

This invention relates to flame retardant compositions which have utility for coating substrates. In particular, this invention relates to flame-retardant plastisol compositions based on polyvinylchloride (PVC), plasticizer and zeolites that are useful as coatings, backings and adhesives for flexible substrates such as woven and non-woven fabrics, carpets and the like.

### FIELD OF THE INVENTION

This invention relates to flame retardant compositions which have utility for coating substrates. In particular, this invention relates to flame-retardant plastisol compositions based on polyvinylchloride (PVC), plasticizer and zeolites that are useful as coatings, backings and adhesives for flexible substrates such as woven and non-woven fabrics, carpets and the like.

### BACKGROUND OF THE INVENTION

Polyvinylchloride plastisols are used in a variety of coating and adhesive applications. In many of these applications, such as textiles, carpeting, paints, clear coatings, adhesives, sealants, caulking, non-woven binders, and a variety of similar applications, the formulations are required to have smoke suppressant and flame retardant properties in order to help prevent smoke generation and flame spread in the event of a fire.

For many woven and non-woven fabrics, it is desirable to apply a backing to the fabric. Backings are applied to carpets, carpet tiles, moldable carpets, liners, covers, mats, moldable mats, rugs, moldable rugs, and other applications. Backings can be used to obtain fiber-lock performance and tuft-lock performance, give stability and structural integrity to the fabric, and afford non-skid characteristics. For example, carpet structures typically have nylon fibers bonded, tufted, or otherwise joined to a primary backing layer, collectively referred to as a face cloth. The face cloth is then bonded to a secondary backing. Such backings can be based on a wide variety of polymers such as PVC, polyesters, polyolefins, styrenics or nylon that are capable of imparting the desired support and durability to the carpet structure. In many cases, these backings are also responsible for imparting flammability properties to the carpet structure.

A plastisol of polyvinylchloride (PVC) can be used to formulate the adhesive that bonds the primary and secondary backing layers together. The adhesive, or binder, is typically coated on the reverse side (i.e., the non-pile side) of the primary backing layer, and the primary backing layer and the secondary backing layer pressed together and the carpet passed through an oven to cure the adhesive layer comprising the PVC plastisol.

Although nylon fibers do not support flames or combustion well, heat from a fire can heat or melt the nylon fibers, which in turn can ignite the adhesive layer, providing a sustained flame source and causing the nylon fibers to burn and emit noxious gases. Consequently, adhesives of this type are typically made flame-retardant by blending flame retardant additives together with the plastisol. However, many flame retardant additives contain either bromine compounds or antimony trioxide. For instance, some carpet backings contain brominated compounds, such as decabromobiphenyl oxide (“decabrome”), and/or antimony trioxide. However, brominated compounds add to the cost of these highly cost-sensitive constructions and antimony trioxide has toxicity problems. Additionally, both brominated compounds and antimony trioxide have high specific gravities and thus will increase the specific gravity of an article fabricated using a composition containing such flame retardants, which in many applications is not desirable. Zinc compounds such as zinc borate and zinc oxide are also typically employed as flame retardant additives, especially in PVC-based formulations. However, many zinc-based flame retardants have negative effects on the thermal stability of the polymer composition. Stabilizers do not always overcome the negative effects of such additives. Thus, a need exists for flame-retardant adhesives that do not have these disadvantages. In particular, a need exists for flame-retardant adhesives and coatings based on PVC plastisols in which the amounts of antimony-, bromine- and/or zinc-containing compounds are reduced or in which the presence of one or more of these types of compounds is completely eliminated, thereby allowing the formulation of improved or “greener” materials with possibly improved costs of manufacture.

Polyvinyl chloride (PVC) is widely used as a component in compositions that are applied as coatings to flexible substrates. In unmodified form, PVC has relatively good flame retardant properties due to its high chloride content. Since PVC by itself is a rigid, inflexible thermoplastic, flexible substrate coating compositions based on PVC are formulated with relatively large amounts of plasticizers to improve the flexibility of the end product. For ease of application and handling, such compositions are often prepared in the form of plastisols comprised of fine particles of PVC suspended or dispersed in a liquid plasticizer matrix. However, the presence of such plasticizers increases the flammability of the final coating obtained from such compositions.

For this reason, various flame retardant and smoke suppressing ingredients are typically incorporated into flexible substrate coating compositions based on PVC plastisols. As is well known, however, it is difficult to simultaneously achieve both adequate flame retardancy and smoke suppression. Compounds that retard flame typically cause incomplete combustion, thereby increasing the amount of smoke generated, while smoke suppressants can function by creating higher heats of combustion to more efficiently consume combustible organic gases. Antimony trioxide, for example, can be an effective flame retardant, but increases the amount of smoke generated in a fire. It would therefore be advantageous to find alternatives to antimony trioxide that retard flame while not contributing to smoke generation.

PVC plastisols are known which are formulated with phosphate ester plasticizers in order to render the plastisols capable of passing various flame retardancy tests, as the phosphate esters have superior flame retardant characteristics as compared to other types of plasticizers. The antagonism between antimony and phosphorus is well known and well documented in the literature, but thus far using both such types of substances in combination has been the only way known to achieve certain desired levels of flame retardancy.

It would therefore be advantageous and beneficial to identify flame retardant synergists that work effectively in the presence of phosphate ester plasticizers without the antagonism typically observed with antimony-based synergists. Additionally, it would be useful if such formulations also produced less smoke than analogous antimony-containing compositions.

### SUMMARY OF THE INVENTION

The present invention provides flame retardant compositions useful as coatings for substrates, particularly flexible substrates. In one aspect, the invention is a plastisol composition comprising:
a) polyvinylchloride;
b) at least one plasticizer;
c) at least one zeolite; and
d) optionally, at least one antimony flame retardant compound;
   wherein the polyvinylchloride is in the form of particles dispersed in plasticizer; and wherein if no antimony flame retardant compound is present then the at least one plasticizer includes at least one phosphate plasticizer and wherein zeolite, phosphate plasticizer and antimony flame retardant compound are present in a total amount effective to render the composition capable of passing the flame-resistant requirements of at least one of NFPA 701, French M1, German Building tests, MVSS 302, or Federal Aviation Administration (FAA) standards.

In another aspect, the invention is an article which comprises: a substrate, which can be rigid or flexible and which can have at least one surface, wherein the at least one surface can have at least a partial coating of a flame retardant composition thereon which is the aforementioned plastisol composition, in cured or uncured form.

In one aspect of the invention, the composition is free of antimony compounds and/or brominated compounds and/or zinc compounds. In another aspect, the invention is a carpet comprising tufted fibers attached to a primary backing layer, an adhesive layer attached to the primary backing layer, and a secondary backing layer attached to the adhesive layer, wherein the adhesive layer comprises the flame retardant plastisol composition of the invention. In still another aspect, the flexible substrate and the flame retardant plastisol composition are selected such that after curing of the plastisol the resulting coated flexible substrate remains flexible (i.e., the cured flame retardant composition coating does not render the substrate inflexible).

### DETAILED DESCRIPTION OF CERTAIN EMBODIMENTS OF THE INVENTION

Parts per hundred resin (phr) refers to parts of additive per one hundred parts of base polymer (e.g., PVC). Unless the context indicates otherwise, in the specification and claims the terms zeolite, plasticizer, stabilizer, filler, antimony compound and similar terms also include mixtures of such materials. The terms filler, flame retardant, stabilizer and smoke suppressant do not include zeolites or ion-exchanged zeolites. Unless otherwise specified, all percentages are percentages by weight and all temperatures are in degrees Centigrade (degrees Celsius).

In one aspect, the invention involves replacing all or a portion of the antimony compound(s) in a flame retardant PVC plastisol composition with zeolite. The flame retardant compositions thereby obtained are particularly useful as adhesives to bind together the primary and secondary backings of carpets.

### Substrate

The substrate may be flexible or inflexible (rigid), but in one embodiment of the invention is in the form of a knit, woven or non-woven fabric, i.e., a thin, flexible material made of any combination of cloth, fiber, polymeric film, sheet or foam. The fabric may be a woven, knitted or non-woven fabric based on, for example, fibers comprised of a synthetic polymer such as a polyolefin (e.g., polyethylene, polypropylene), a polyester (e.g., polyethylene terephthalate), or polyamide, a natural polymer such as cellulose or cotton, or even an inorganic substance such as glass. The substrate may also be in the form of a paper, e.g., a felted or matted sheet of cellulose fibers. Biodegradable polymers may also be used to fabricate the substrate. The substrate may be a layer of a single substance or have a multilayer structure, where the individual layers are comprised of different materials. Rubbers and elastomers, which may be in solid, foamed or fibrous form, may also be utilized to provide suitable flexible substrates.

Rigid substrates may be constructed of any suitable material, but in one embodiment of the invention the rigid substrate is comprised of an inflexible thermoplastic or thermoset (crosslinked) material, which can be in solid, foamed or other form. Such materials are well known in the art and include, for example, epoxies, polyesters (including unsaturated polyesters), polyurethanes, polyacrylates, polycarbonates, polyethers, polystyrenes, polyolefins, PVC (and other vinyl polymers), which can be admixed or formulated with other components such as fillers, reinforcing agents, pigments, stabilizers and the like. The rigid substrate may also be a cellulosic material such as wood, plywood, particle board, chip board, fiberboard, cardboard, or the like or a metallic material such as steel, aluminum, alloys or the like. Additionally, composites or laminates can be utilized as the substrate.

### Flame Retardant Composition

### Polyvinylchloride (PVC)

The PVC is initially in the form of a plastisol, i.e., a suspension or dispersion of particles of the organic polymer in a plasticizer medium (a volatile solvent may also be present).

The use of such a plastisol can assist in providing a coating composition that can be more readily applied to a substrate by techniques such as spraying, dipping, brushing, roller coating, knife coating, blade coating, rod coating, extrusion coating and so forth. Once the coating composition has been applied to the substrate surface, heating the coating results in “curing” of the polyvinylchloride/plasticizer mixture (i.e., rigid PVC is transformed to a rubberlike material).

The polyvinylchloride used can be any of the types of resins obtained by polymerization of vinyl chloride monomer that are conventionally used to prepare PVC plastisols.

### Zeolites

Zeolites are natural or synthetic microporous crystalline inorganic compounds with three dimensional structures and generally contain silicon, aluminum, and oxygen in their framework and loosely held cations, water and/or other molecules in their pores. More particularly, zeolites are aluminosilicates comprised of interlocking tetrahedrons of SiO₄ and AlO₄. The SiO₄ and AlO₄ structural elements impart a net negative charge to the pores that are responsible for holding the cations inside the pores and permits these cations to be readily exchanged with other cations.

In the present invention, the zeolite functions as a flame retardant, as a synergist in cooperation with other types of flame retardants that may be present in the flame retardant composition, and also as a smoke suppressant. These characteristics permit the flame retardant composition to be formulated with reduced amounts of conventional synergists such as antimony compounds, as compared to conventional flame retardant compositions, while still maintaining good flame retardancy properties and reducing the amount of smoke generated by the composition when ignited. In one embodiment, the zeolite interacts synergistically with a phosphate plasticizer to provide exceptionally effective flame retardancy without the presence of higher levels of antimony-based retardants which are generally required to achieve such performance.

Natural zeolites are aluminosilicates that can be represented by the general formula:

M_{a/n}O[(Al₂O₃)_{b}(SiO₂)_{c}].xH₂O

where M is a metal ion such as Na⁺, K⁺, Ca⁺², or Mg⁺²; n is the valence of the metal ion M; a, b, c, and x are positive integers, where the ratio a:n=2 and the ratio c:b is between 1:1 and 5:1. An example is the natural zeolite, natrolite, which has the structure:

Na₂O[(Al₂O₃)(SiO₂)₃].2H₂O.

The aluminosilicate structure is negatively charged and attracts the positive cations that reside within. When exposed to higher charged ions of a new element, zeolites will exchange the lower charged ions contained within the zeolite for the higher charged ions of the new element.

Examples of natural zeolites include: clinoptilolite (hydrated sodium, potassium, calcium aluminosilicate); analcime or analcite (hydrated sodium aluminum silicate); chabazite (hydrated calcium aluminum silicate); harmotome (hydrated barium potassium aluminum silicate); heulandite (hydrated sodium calcium aluminum silicate); laumontite (hydrated calcium aluminum silicate); mesolite (hydrated sodium calcium aluminum silicate); natrolite (hydrated sodium aluminum silicate); phillipsite (hydrated potassium sodium calcium aluminum silicate); scolecite (hydrated calcium aluminum silicate); stellerite (hydrated calcium aluminum silicate); stilbite (hydrated sodium calcium aluminum silicate); and thomsonite (hydrated sodium calcium aluminum silicate). Natural zeolites suitable for use in the present invention are available from many commercial sources, including Zeo, Inc. of McKinney, Tex.

Synthetic zeolites can be made by slow crystallization of silica-alumina gels in the presence of alkalis and organic templates. The exact composition and structure of the product formed depend on the composition of the reaction mixture, pH of the medium, operating temperature, reaction time, and the template used.

Commercially available zeolites include several products of Nippon Chemical, sold as the “Zeostar” zeolites, including: Zeostar CA-100P and Zeostar CA-110P; Zeostar CX-100P and Zeostar CX-110P; Zeostar KA-100P and Zeostar KA-110P; Zeostar NA-100P and NA-110P; and Zeostar NX-100P and Zeostar NX-110P; and the VALFOR® zeolites and ADVERA® zeolites, such as VALFOR® 100 sodium aluminosilicate hydrated type Na-A zeolite powder and ADVERA® 401/401P hydrated sodium zeolite A (PQ Corp., Valley Forge, Pa.).

Zeolites useful in the invention can either be a natural, synthetic, or a mixture thereof. The zeolite can be untreated or surface treated with such materials as higher fatty acids and their salts such as stearic acid, oleic acid, and salts of stearic acid and oleic acid, or salts of higher alkyl-, aryl-, or alkylaryl-sulfonic acids such as of dodecylbenzenesulfonic acid or the like. The zeolite may be calcined or uncalcined. Calcining may carried out at 200° C. to 700° C. for a period of 1-10 hours, typically at 300° C. to 500° C. for a period of 2-5 hours.

The zeolite may also be an ion-exchanged zeolite, that is, a zeolite composition in which the alkali metal ions and/or alkaline earth ions of the aluminosilicate structure have been at least partially replaced by another metal ion. Typical metal ions that may be used include cations of V, Mo, Mn, Fe, Co, Ni, Cu, Zn, Sb, B, and mixtures thereof.

Ion-exchanged zeolites may be produced by stirring a mixture of the zeolite in an aqueous solution containing a water-soluble salt of the desired metal. In certain instances, it is preferable to stir the zeolite in a concentrated solution of sodium chloride in order to exchange sodium for the difficulty released potassium, calcium, and magnesium ions and then to effect further exchange of the sodium ions in a solution of the desired metal ion. The exchange may be carried out at about 20° C. to about 100° C., typically at about 40° C. to about 80° C.

Although adducts of zeolites and inorganic halides have been employed as components of self-extinguishing polymeric compositions (see U.S. Pat. No. 5,149,735, incorporated herein by reference in its entirety), in preferred embodiments of this invention the flame retardant composition does not contain such adducts.

Preferably, the zeolite is incorporated into the flame retardant plastisol composition in the form of finely divided particles, where the average particle size may be, for example, less than 100 microns or less than 50 microns or even less than 10 microns.

Typically, the flame retardant plastisol composition will be comprised of at least 1 weight % or at least 2 weight % zeolite. However, in at least certain types of formulations useful within the scope of the present invention, it has been found that even relatively low levels of zeolite can be surprisingly effective in improving the flame retardant properties of the composition. Thus, in certain embodiments of the invention, the composition contains not more than 10 or not more than 5 weight % of zeolite.

### Plasticizers

One or more plasticizers, sometimes known as flexibilizers or flexibilizing agents, are incorporated into the flame retardant composition to increase its flexibility, especially where the organic polymer employed is a polyvinyl chloride. Examples of suitable plasticizers include phthalate esters, phosphate esters, adipate esters, and sebacate esters. Typical phthalate esters are dimethyl phthalate (DMP), diethyl phthalate (DEP), dibutyl phthalate (DBP), dihexyl phthalate (DHP), di-2-ethylhexyl phthalate (DOP), diisodecyl phthalate (DIDP), butylbenzyl phthalate (BBP), diisononyl phthalate (DINP), and dinonyl phthalate (DNP). Typical adipate esters are dioctyl adipate (DOA) and diisodecyl adipate (DIDA). Typical sebacate esters are dibutyl sebacate (DBS) and dioctyl sebacate (DOS).

Phosphate ester plasticizers are especially advantageous, as such plasticizers have surprisingly been found to provide synergistic improvements in flame retardancy when combined with one or more zeolites. The phosphate ester plasticizers may be used alone or in combination with one another. Suitable examples of phosphate ester plasticizers useful in the present invention include triaryl phosphates, such as triphenyl phosphate, tricresyl phosphate, and other substituted triarylphosphates, as well as alkyl diphenyl phosphates (e.g., isodecyldiphenyl phosphate, such as PHOSFLEX 390®) and alkyl diaryl phosphates. REOFOS® 35 and REOFOS® 50, products offered by Chemtura, Inc., are isopropylated triaryl phosphate esters that have been found to be particularly effective. In various embodiments of the invention, 20, 40, 60, 80 or 100% of the plasticizer present in the plastisol composition is a phosphate ester plasticizer or mixture of phosphate ester plasticizers.

Halogenated plasticizers, including chlorinated plasticizers and brominated plasticizers, may be used as plasticizers. Chlorinated polyethylene (CPE), prepared by chlorination of polyethylene and typically comprising about 22 wt % to 60 wt chlorine, is a suitable halogenated plasticizer. Brominated plasticizers offer slight plasticizing effects but their halogen content provides extra flame retardancy. Examples of brominated plasticizers include brominated di-octyl phosphate and a tetrabromophthalate ester (bis(2-ethylhexyl)tetrabromophthalate) sold under the trade names DP-45 (Great Lakes, West Lafayette, Ind. USA) and Uniplex FRP-45 (Unitex Chemical, Greensboro). Other plasticizers include: polymeric plasticizers, such as ethylene/acrylate/carbon monoxide terpolymers, for example ELVALOY® HP-441 (DuPont, Wilmington, Del. USA); fatty acid esters of pentaerythritol, such as HERCOFLEX 707 and HERCOFLEX 707A (Hercules, Wilmington Del.); alkyl trimellitates, such as PX-336, a trialkyl ester of 1,2,4-benzene tricarboxylic acid (trimellitic acid); and diesters of aliphatic diacids, such as dioctyl sebacate.

The plasticizer or mixture of plasticizers can, in certain embodiments, be present in the flame retardant composition in an amount of at least about 20 phr, at least about 30 phr, or at least 40 phr and not more than about 100 phr, not more about 90 phr, or not more than about 80 phr. The amount of plasticizer, in any event, must be sufficient to provide a plastisol, i.e., a dispersion or suspension of PVC particles in the plasticizer or mixture of plasticizers.

### Antimony Compounds

Antimony compounds, such as antimony tetroxide, antimony pentoxide, sodium antimonate, antimony tartrate, and especially antimony trioxide act as synergists, increasing the performance of halogenated flame retardants to lower the heat release rate and inhibit flame propagation. However, not only is antimony toxic, it contributes to smoke release and at certain levels may be antagonistic to phosphate plasticizers. Because zeolites have been found to act as effective flame retardants as well as smoke suppressants, the level of antimony compounds in the composition may be reduced when a zeolite or a mixture of zeolites is incorporated into the flame retardant composition to be utilized as a coating or adhesive. In certain embodiments of the invention, the total amount of antimony compound and zeolite in the composition is less than or equal to about 8 weight %, less than or equal to about 6 weight %, or less than or equal to about 4 weight %. The ratio of the weight of the antimony compound to the weight of the zeolite can, in certain embodiments, be 0 to about 1.25, 0 to about 1.2, 0 to about 1.1, or 0 to about 1.0.

### Fillers

The flame retardant plastisol composition used as a coating, backing or adhesive in the present invention may further comprise a filler or a mixture of fillers. Typical fillers are inorganic particulate fillers such as metal oxides, particularly hydrated metal oxides such as hydrated aluminum oxide (alumina trihydrate, Al₂O₃.3H₂O), magnesium hydroxycarbonate, and magnesium hydroxide. These materials are active fillers, providing the normal benefits of a filler along with additional flame retardation upon thermal decomposition. Barium sulfate is another example of a suitable inorganic particulate filler. Other types of inorganic particulate fillers such as magnesium oxide, calcined koalin clay, talc, and metal carbonates (such as calcium carbonate and magnesium carbonate), although not flame-retardant per se and thus not regarded as active fillers, may be employed to help reduce the spread of flaming droplets. The composition may comprise about 0.1 to about 30 weight of a filler or a mixture of fillers. The term fillers as used herein does not include zeolites or antimony compounds.

### Halogenated Organic Flame Retardant Compounds

In certain embodiments of the invention, the incorporation of one or more halogenated organic flame retardant compounds has been found to be advantageous. Any of the conventional halogenated organic flame retardant compounds may be utilized, including brominated as well as chlorinated compounds. Examples of suitable chlorinated organic flame retardant compounds include polychlorinated paraffins.

### INDUSTRIAL APPLICABILITY

The flame retardant plastisol composition may be applied to a surface of a substrate by any conventional method, for example, by brushing, roll coating, spraying, dipping, extrusion, troweling or the like. The entire surface of the substrate or only a portion thereof in some preselected pattern may be coated with a layer of the flame retardant plastisol composition. The thickness of the applied coating may be varied as desired depending upon the particular end-use application, but typically will be from about 1 to about 50 microns. Where the substrate is porous or otherwise contains openings, the flame retardant composition may penetrate into such pores or openings. The coated substrate may be heated in an oven or by other means to obtain a “cured” coating of the flame retardant plastisol composition, wherein the plastisol is converted to a plasticized rubberlike composition.

The flame retardant plastisol composition may also be utilized as an adhesive to bond a first substrate and a second substrate. For example, a layer of the flame retardant composition may be applied to a surface of a first substrate to form a coated first substrate. The surface of the coated first substrate bearing the flame retardant plastisol composition layer may then be brought into contact with a surface of a second substrate, with the flame retardant plastisol composition layer positioned between the first substrate and second substrate such that it can function as an adhesive. “Curing” of the flame retardant plastisol composition layer can be delayed until after the first and second substrates are joined, since the adhesion of the substrates may thereby be enhanced. Alternatively, a “cured” flame retardant plastisol composition may be heated immediately before or while being brought into contact with the second substrate surface so as to soften the cured flame retardant plastisol composition layer to improve its ability to adhere to such second substrate surface upon cooling. Adhesion of the two substrates may be further improved by pressing together the substrates.

The coating of flame retardant plastisol composition may also function as a sealant, mastic, binder, caulk, putty or the like.

The present invention can be readily adapted for use in a wide variety of end use applications, e.g., in the fields of construction, transportation, telecommunications, utilities, marine, chemical, petroleum, manufacturing and military, the hygiene sector, the medical sector, the textile and clothing industry, automobile applications, packaging, pharmacy, electrical engineering, electronics and domestic appliances. For example, the article comprising the substrate having at least a partial coating of the flame retardant composition coated thereon can be a carpet (including carpet tile), a mat, a wall paper or other wall covering, a mattress cover or ticking, a curtain, a tent, an awning, an article of clothing, a furniture covering (e.g., upholstery), an automobile or other transportation vehicle interior covering material (e.g., a seat cover, headliner, or door panel covering), or the like.

The present invention is particularly useful in the manufacture of tufted pile carpets. Tufted pile carpets typically include a secondary backing forming their lower surface and a primary backing tufted with yarns forming their upper surface. The yarn used in forming the pile of a tufted carpet is typically made of fibers of any of a number of materials, e.g., nylon, acrylics, polypropylene, polyethylene, polyamides, polyesters, wool, cotton, rayon and the like. Primary backings for tufted pile carpets are typically woven or non-woven fabrics made of one or more natural or synthetic fibers or yarns, such as jute, wool, polypropylene, polyethylene, polyamides, polyesters, nylon and rayon. Films of synthetic materials, such as polypropylene, polyethylene and ethylene-propylene copolymers may also be used to form the primary backing. Secondary backings for tufted pile carpets are typically woven or non-woven fabrics made of one or more natural or synthetic fibers or yarns.

The flame retardant plastisol composition described herein may be utilized as an adhesive or binder to bond the primary backing and secondary backing together. The flame retardant plastisol composition may be applied as a coating on the reverse side (i.e., the non-pile side) of the primary backing layer, and the primary backing layer and the secondary backing layer pressed together by rollers. The carpet is then passed through an oven to cure the plastisol. The cured layer of flame retardant plastisol composition binds the tufted primary backing to the secondary backing.

The advantageous properties of this invention can be observed by reference to the following examples, which illustrate but do not limit the invention.

### EXAMPLES

TABLE 1
Table 1: Partial Replacement of Antimony

| | | Commercial | | | | | |
|---|---|---|---|---|---|---|---|
| | | Product | | | | | |
| | | prepared | | | | | |
| | Commercial | under same | | | | | |
| | Product with | conditions as | | | | | |
| | antimony | new formulas | | | | | |
| | 1 | 2 | 27 | 28 | 29 | 30 | 31 |
| Base resin and | | 84 | 84 | 84 | 84 | 83.5 | 84 |
| additives | | | | | | | |
| Zeolite | | | 1.5 | 1 | 2 | 2 | 3 |
| Calcium Carbonate | | 12.5 | 12.5 | 12.5 | 12.5 | 12.5 | 12 |
| Antimony Trioxide | | 3.5 | 2 | 2.5 | 1.5 | 2 | 1 |
| | | 100 | 100 | 100 | 100 | 100 | 100 |
| NFPA 701 | Pass-3″ | Pass-2.94 | Pass-3.17 | Pass-3.00 | Pass-3.92 | Pass-3.33 | Pass-4.58 |
| Oxygen Index | 27 | 28 | 27 | 27 | 26 | 27 | 25 |
| Whiteness ASTM | | 76.29 | 73.96 | 76.16 | 71.12 | 74.02 | 71.7 |
| Specific Gravity | 1.404 | 1.402 | 1.396 | 1.396 | 1.391 | 1.389 | 1.381 |

### Table 2.

TABLE 2

| | | Control | | |
|---|---|---|---|---|
| | | Commercial | | |
| | | Product | | |
| | Control | prepared | | |
| | Commercial | under same | | |
| | Product | conditions | | |
| | with | as new | | |
| | antimony | formulas | | |
| | 1 | 2 | 21 | 23 |
| Base Resin and | | 84 | 79 | 79 |
| additives | | | | |
| Zeolite | | | 3 | 3 |
| Alumina Trihydrate | | | 15 | 10 |
| Calcium Carbonate | | 12.5 | 0 | 5 |
| Antimony Trioxide | | 3.5 | 0 | 0 |
| Phosphate | | | 3 | 3 |
| Plasticizer | | | | |
| | | 100 | 100 | 100 |
| NFPA 701 | Pass-3″ | Pass-2.94 | Pass-4.17 | Pass-3.33 |
| Oxygen Index | 27 | 28 | 27 | 26 |
| Whiteness ASTM | | 76.29 | 71.5 | 73.7 |
| Specific_Gravity | 1.404 | 1.402 | 1.384 | 1.376 |

TABLE 3

| | phr | % | Control 1 | 2 | 2A | 3 | 3A | 5 | 5A | 6 | 7 | 7A |
|---|---|---|---|---|---|---|---|---|---|---|---|---|
| Resin and | | | 63.5 | 63.5 | 63.5 | 63.5 | 63.5 | 63.5 | 63.5 | 63.5 | 63.5 | 63.5 |
| additives | | | | | | | | | | | | |
| Resin | 97 | 40.36 | | | | | | | | | | |
| Processing | 56.3 | 23.45 | | | | | | | | | | |
| Aids and | | | | | | | | | | | | |
| Plasticizers | | | | | | | | | | | | |
| CaCO3 | 20 | 8.32 | 8.5 | 8.5 | 8.5 | 8.5 | 8.5 | 8.5 | 8.5 | 6 | 8.5 | 8.5 |
| Other solid | 25 | 10.41 | 10.5 | 8.5 | 8.5 | 8.5 | 8.5 | 8.5 | 8.5 | 11 | 8.5 | 8.5 |
| fillers | | | | | | | | | | | | |
| ATH | 10 | 4.16 | 4 | 4 | 4 | 4 | 4 | 4 | 4 | 4 | 4 | 4 |
| Phosphate | 25 | 10.41 | 10.5 | 10.5 | | 10.5 | | | | 10.5 | 10.5 | |
| Plasticizer A | | | | | | | | | | | | |
| Sb2O3 | 7 | 2.91 | 3 | 0 | | 1 | 1 | 0 | | 0 | 0.5 | 0.5 |
| Zeolite | | | | 3 | 3 | 2 | 2 | 3 | 3 | 3 | 2.5 | 2.5 |
| Phosphate | | | | | | | | 11 | | 0 | | |
| Plasticizer B | | | | | | | | | | | | |
| Phosphate | | | | | 10.5 | | 10.5 | | 11 | | | 10.5 |
| Plasticizer C | | | | | | | | | | | | |
| | 240.35 | 100 | 100 | 100 | | 100 | | 100 | | 100 | | |
| TESTS | | | | | | | | | | | | |
| FMVSS 302 | | Pass | Pass | Pass | Pass | Pass | Pass | Pass | Pass | Pass | Pass | Pass |
| OI | | 29 | 28 | 27 | 27 | 28 | 27 | 26 | 27 | 27 | 27 | 27 |
| CCC 680- | | Pass | Pass | Pass | Pass | Pass | Pass | Pass | Pass | Fail | Pass | Pass |
| Vertical Burn | | | | | | | | | | | | |
| Char Length- | | 3-3- | 4- | 3¼- | 4-4- | 3¼-4- | 2¾-3- | 3½ | 3-2¾- | 4-4¾-4 | 3¼-3¼-3 | 2½-2¾- |
| (in) max-4½″ | | 3¾ | 3½-3 | 3½-4¼ | 4.25-4.25 | 3½ | 3-3 | 3¾ 4¼ | 2/¾-3 | | | 2¾-2¾ |
| Char Length- | | 3.35 | 3.5 | 3.67 | 4.13 | 3.48 | 2.94 | 3.83 | 2.88 | 4.25 | 3.17 | 2.69 |
| avg.--inches | | | | | | | | | | | | |
| After Flame | | 0 | 0 | 0 | 0 | 0 | 0 | 0 | 0 | 0 | 0 | 0 |
| time-2 sec. | | | | | | | | | | | | |
| After Glow | | 0 | 0 | 0 | 0 | 0 | 0 | 0 | 0 | 0 | 0 | 0 |
| Sp. Gr. | | 1.475 | 1.474 | 1.457 | 1.46 | 1.455 | 1.462 | 1.441 | 1.441 | 1.451 | 1.45 | 1.45 |

What is claimed is:

1. A plastisol composition useful as a coating, adhesive or backing, comprising:
a) polyvinylchloride;
b) at least one plasticizer;
c) at least one zeolite; and
d) optionally, at least one antimony flame retardant compound;
wherein the polyvinylchloride is in the form of particles dispersed in plasticizer; and
wherein if no antimony flame retardant compound is present the at least one plasticizer includes at least one phosphate plasticizer and wherein zeolite, phosphate plasticizer and antimony flame retardant compound are present in a total amount effective to render the composition capable of passing the flame-resistant requirements of NFPA 701.

2. The plastisol composition of claim 1, additionally comprising at least one inorganic substance selected from the group consisting of calcium carbonate, aluminum trihydrate, and barium sulfate.

3. The plastisol composition of claim 1, additionally comprising a chlorinated paraffin.

4. The plastisol composition of claim 1, wherein no antimony flame retardant compound is present.

5. The plastisol composition of claim 1, wherein the amount of antimony flame retardant compound is not greater than 2.5 weight % based on the total weight of the plastisol composition.

6. The plastisol composition of claim 1, wherein the amount of antimony flame retardant compound is not greater than 2 weight % based on the total weight of the plastisol composition.

7. The plastisol composition of claim 1, wherein the amount of antimony flame retardant compound is not greater than 1.5 weight % based on the total weight of the plastisol composition.

8. The plastisol composition of claim 1, wherein the amount of zeolite is at least 1.5 weight % based on the total weight of the plastisol composition.

9. The plastisol composition of claim 1, wherein the amount of zeolite is at least 2 weight % based on the total weight of the plastisol composition.

10. The plastisol composition of claim 1, wherein the total amount of zeolite and antimony flame retardant is at least 3 weight % based on the total weight of the plastisol composition.

11. The plastisol composition of claim 1, wherein the total amount of zeolite and antimony flame retardant is not greater than 6 weight % based on the total weight of the plastisol composition.

12. The plastisol composition of claim 1, wherein no antimony fire retardant compound is present and phosphate plasticizer is present in an amount of at least 2 weight % based on the total weight of the plastisol composition.

13. A floorcovering, comprising:
a) a backing comprised of the plastisol composition of claim 1;
b) a carpet web.

14. A method for making a floorcovering, comprising forming a backing comprised of the plastisol composition of claim 1 and bonding the backing to a carpet web.
